(19) United States
(12) Patent Application Publication
(10) Pub. No.: US 2025/0003921 A1
(43) Pub. Date: Jan. 2, 2025

(54) METHOD FOR OPERATING AN ELECTROCHEMICAL MEASURING POINT AND ELECTROCHEMICAL MEASURING POINT

(71) Applicant: Endress+Hauser Conducta GmbH+Co. KG, Gerlingen (DE)

(72) Inventor: Björn Haase, Stuttgart (DE)

(21) Appl. No.: 18/756,132

(22) Filed: Jun. 27, 2024

(30) Foreign Application Priority Data
Jun. 29, 2023 (DE) 10 2023 117 274.3

(51) Int. Cl. G01N 27/416; G01N 27/30

(52) U.S. Cl. CPC G01N 27/4165; G01N 27/302

(57) ABSTRACT

A method for operating an electrochemical measuring point comprises providing an electrochemical measuring point with a sensor circuit, a first cable, at least one first electrochemical half-cell, wherein the sensor circuit has a control unit with a first digital-analog converter, a first analog-digital converter, and a second digital-analog converter, wherein the sensor circuit furthermore has a first terminal, a second terminal, and a first input filter between the second digital-analog converter and the second terminal, measuring a first electrode signal of the first electrochemical half-cell at the second terminal, outputting a superposition of a first DC voltage signal with a first AC voltage signal at the first terminal by the first digital-analog converter, and evaluating the first electrode signal at the first analog-digital converter, so that an AC voltage amplitude shift and/or a phase shift between the AC voltage signal and the first electrode signal is determined.

### CROSS-REFERENCE TO RELATED APPLICATION

The present application is related to and claims the priority benefit of German Patent Application No. 10 2023 117 274.3, filed on Jun. 29, 2023, the entire contents of which are incorporated herein by reference.

### TECHNICAL FIELD

The present disclosure relates to a method for operating an electrochemical measuring point and to an electrochemical measuring point.

### BACKGROUND

In analytical measurement technology, especially in the fields of water management, of environmental analysis, in industry, e.g. in food technology, biotechnology, and pharmaceutics, as well as for the most varied laboratory applications, measured variables, such as the pH, the conductivity, or even the concentration of analytes, such as ions or dissolved gases in a gaseous or liquid measurement medium, are of great importance. These measured variables can be detected and/or monitored, for example, by means of electrochemical sensors. Electrochemical sensors for measuring the pH of a measurement medium are generally constructed from two electrochemical half-cells.

A half-cell consists, for example, of a so-called reference cell with an electrically contacted electrolyte fluid which is conductively connected to the measurement medium via a diaphragm. Another possible half-cell consists of an electrically contacted buffer solution having a defined pH value, for example for measuring the pH, which buffer solution is separated from the measurement medium by a thin glass barrier. Furthermore, it is possible for a half-cell to be made via a metal contact directly electrically connected to the measurement medium, for example a noble metal contact, or via an enamel membrane.

In the following, electrochemical half-cells will be addressed, but the present disclosure and the associated advantages can however be used by a person skilled in the art for any sensor configuration, in particular also for one-piece configurations. Various configurations are described by the equivalent circuit diagrams of FIGS. 1 and 2. Therein, for example, the above-mentioned subcomponents are not configured in so-called single electrodes, but in so-called combination electrodes. The electrical voltages generated in the electrochemical half-cells enable conclusions to be drawn about the chemical properties of the measurement medium.

In this document, the term “half-cells” is used to describe all subcomponents of the sensor which have a direct contact with the measurement medium or the analyte. The term “electrochemical measuring point” is used for the overall system which consists of electronics, possibly cable connections and the half-cells.

Electrochemical half-cells regularly have a very high impedance, for example 5 gigaohms or more. The measurement of the voltages generated by the electrochemical half-cells is therefore to be realized with cabling and evaluation electronics with a sensor circuit whose components are designed with particularly high impedance. Otherwise, measurement errors arise, e.g., due to leakage currents. The design of the sensor cable is particularly relevant here, since this is often exposed to moisture or vapors and can often reach great lengths, for example of 50 m. For the same reason, the corresponding electronic components for signal evaluation must generally be time-consumingly cleaned, or cast, or painted in order to prevent leakage currents through flux residues or solder residues. A method known from the prior art for protecting leakage currents with high-impedance input signals is to use so-called guard potentials or protective potentials, i.e. low-impedance driven signals which are set to the same voltage as the critical high-impedance input signal. In this case, the low-impedance signal is routed in a so-called protective line in a ring around the high-impedance input line with the input signal. This means that no leakage current can flow between the input line and the protective line. Over the course of this, a certain amount of feedback capacitance is also inevitably applied between the input line and the protective line. In practice, therefore, this principle can only be used within limits, namely if the feedback capacitance assumes a sufficiently small amount, since otherwise the feedback coupling mediated by the capacitance will cause the system to tend to oscillate.

In the patent application DE 10 2021 107 754 A1, the applicant proposes a solution to make guard potentials or protective potentials less dependent on the feedback capacitance. One starting point in this case is not to change the guard potentials or protective potentials in stages or quickly, but to adjust them slowly using a digital method. However, this gain in the robustness of the circuit can, under certain conditions, entail an increased latency in the stabilization of the measured value, in particular with rapid changes in the measurement medium. This latency of the measurement signal, for example of a voltage, is visible in particular in FIG. 4 from the dashed curve in the form of an overshoot compared to an ideal voltage curve (full curve). This overshoot is caused by the fact that even with slow ramped tracking of the guard potentials, charge/discharge currents flow via the filter capacitors of the circuit and via the connected cable capacitances. This aspect is relevant in particular when the charge/discharge currents flow via a sensor half-cell which has a high internal resistance.

### SUMMARY

It is therefore an object of the present disclosure to provide a circuit which has optimum properties in terms of robustness and response time to changes in measurement signals.

This object is achieved according to the present disclosure by a method for operating an electrochemical measuring point.

The method according to the present disclosure comprises the following steps:
providing an electrochemical measuring point with a sensor circuit, a first cable, at least one first electrochemical half-cell, wherein the sensor circuit has a control unit with a first digital-analog converter, a first analog-digital converter, and a second digital-analog converter, wherein the sensor circuit furthermore has a first terminal, a second terminal, and a first input filter arranged between the second digital-analog converter and the second terminal,
measuring a first electrode signal of the first electrochemical half-cell at the second terminal,
outputting a superposition of a first DC voltage signal with a first AC voltage signal at the first terminal by the first digital-analog converter,
evaluating the first electrode signal at the first analog-digital converter so that an AC voltage amplitude shift and/or a phase shift between the AC voltage signal and the first electrode signal is determined,
determining a first half-cell impedance of the first electrochemical half-cell based on the AC voltage amplitude shift and/or the phase shift,
determining a filter capacitance of the first input filter and/or a cable capacitance of the first cable,
determining a time derivative of the first electrode signal and a time derivative of the DC voltage signal GS1,
determining a first correction value based on the time derivative of the first electrode signal and the time derivative of the first DC voltage signal and the first half-cell impedance,
determining a measured value based on the first electrode signal,
determining a display value based on the measured value and the first correction value,
outputting the display value.

By using the method according to the present disclosure, it is possible for measured value distortions, so-called voltage overshoots, to be corrected in the output display value. This allows a more precise measured value display which, when the measured value changes, has an optimum response time in the measured value display.

According to one embodiment of the present disclosure, a guard voltage is output by the digital-analog converter to the second terminal, and a displacement current is determined based on a voltage difference between the first terminal and the second terminal and the cable impedance, wherein the displacement current is taken into account in the step of determining the correction value.

According to one embodiment of the present disclosure, a time period of less than 3 seconds is used when determining the time derivative of the first electrode signal.

According to one embodiment of the present disclosure, a cable length of the first cable entered by the user is taken into account when determining the cable capacitance.

According to one embodiment of the present disclosure, when determining the half-cell impedance, a median filtering is applied to values of the determined AC voltage amplitude shift and/or values of the determined phase shift, in particular a median filtering over a period of more than 3 seconds.

The above-mentioned object is also achieved by a method for operating an electrochemical measuring point.

The method according to the present disclosure comprises the following steps:
providing an electrochemical measuring point with a sensor circuit, a first cable, a second cable, a third cable, a first electrochemical half-cell, and a second electrochemical half-cell, wherein the sensor circuit has a control unit with a first digital-analog converter, a first analog-digital converter, and a second digital-analog converter, wherein the sensor circuit furthermore has a first terminal, a second terminal, and a first input filter arranged between the second digital-analog converter and the second terminal,
measuring a first electrode signal of the first electrochemical half-cell at the second terminal,
determining a time derivative of the first electrode signal and a time derivative of the second electrode signal at the fourth terminal,
outputting a superposition of a first DC voltage signal with a first AC voltage signal at the first terminal by the first digital-analog converter,
evaluating the first electrode signal at the first analog-digital converter and evaluating the second electrode signal at the second analog-digital converter so that in each case an AC voltage amplitude shift and/or a phase shift between the DC voltage signal or the AC voltage signal and the first and second electrode signal is determined,
determining a first half-cell impedance of the first electrochemical half-cell and a second half-cell impedance of the second electrochemical half-cell based on the AC voltage amplitude shift and/or the phase shift,
determining a first correction value based on the time derivative of the first electrode signal and the first half-cell impedance of the first half-cell,
determining a second correction value based on the time derivative of the second electrode signal and the second half-cell impedance of the second half-cell,
determining a measured value based on the first electrode signal and the second electrode signal,
determining a display value based on the measured value and the first correction value and the second correction value,
outputting the display value.

The above object is also achieved by an electrochemical measuring point.

The electrochemical measuring point according to the present disclosure comprises:
a sensor circuit having a control unit which is suitable for carrying out the method according to the present disclosure, wherein the sensor circuit further comprises a first terminal and a second terminal,
a first cable having an inner conductor and a shielding, wherein the shielding is connected to the first terminal and the inner conductor is connected to the second terminal,
a first electrochemical half-cell having an input and an output, a second electrochemical half-cell having an input and an output,
wherein the input of the first electrochemical half-cell is suitable for being connected to the measurement medium, and the output of the first electrochemical half-cell is connected to the shielding,
wherein the input of the second electrochemical half-cell is suitable for being connected to the measurement medium, and the output of the second electrochemical half-cell is connected to the inner conductor.

The above object is also achieved by an electrochemical measuring point.

The electrochemical measuring point according to the present disclosure comprises:
a sensor circuit having a control unit which is suitable for carrying out the method according to the present disclosure, wherein the sensor circuit further comprises a first terminal, a second terminal, a third terminal, a fourth terminal and a fifth terminal,
a first electrochemical half-cell having an input and an output, a second electrochemical half-cell having an input and an output,
a first cable having an inner conductor and a shielding, wherein the inner conductor of the first cable is connected to the second terminal and to the output of the second half-cell, and the third terminal is connected to the shielding of the first cable,
a second cable having an inner conductor and a shielding, wherein the inner conductor of the second cable is connected to the fourth terminal and to the output of the first half-cell, and the shielding of the second cable is connected to the fifth terminal,
a third cable, wherein the third cable is connected to the first terminal and is connected to the input of the first half-cell and to the input of the second half-cell.

The above object is also achieved by an electrochemical measuring point.

The electrochemical measuring point according to the present disclosure comprises:
a sensor circuit having a control unit which is suitable for carrying out the method according to the present disclosure, wherein the sensor circuit comprises a first terminal, a second terminal, a third terminal and a fourth terminal,
a first electrochemical half-cell having an input and an output, a second electrochemical half-cell having an input and an output,
a first cable having an inner conductor and a shielding, wherein the inner conductor of the first cable is connected to the second terminal and to the output of the second half-cell, and the fourth terminal is connected to the shielding of the first cable,
wherein the shielding is further connected to the output of the first half-cell,
a third cable, wherein the third cable is connected to the first terminal and is connected to the input of the first half-cell and to the input of the second half-cell.

### BRIEF DESCRIPTION OF THE DRAWINGS

The present disclosure is explained in more detail on the basis of the following description of the figures. In the figures:

FIG. 1 shows a schematic representation of an electrochemical measuring point according to the present disclosure with a sensor circuit according to the present disclosure,

FIG. 2 shows an alternative embodiment of the electrochemical measuring point shown in FIG. 1 with an alternative sensor circuit,

FIG. 3 shows an alternative embodiment of the electrochemical measuring point shown in FIG. 1 with an alternative sensor circuit,

FIG. 4 shows a schematic diagram of an ideal, real and corrected displayed measurement signal curve.

### DETAILED DESCRIPTION

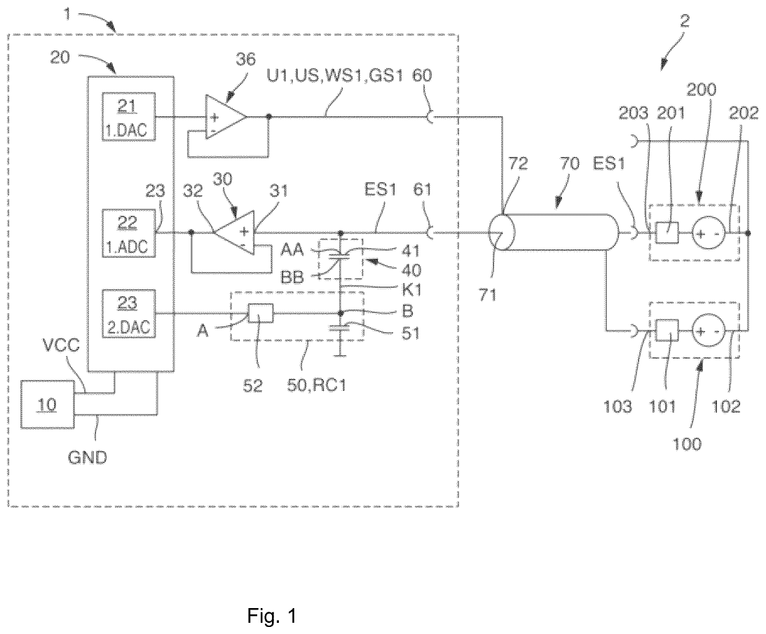

FIG. 1 shows a first embodiment of an electrochemical measuring point 2 according to the present disclosure with a sensor circuit 1 according to the present disclosure, a first cable 70, a first electrochemical half-cell 100, and a second electrochemical half-cell 200. In one embodiment (not shown), the electrochemical measuring point 2 has only the first electrochemical half-cell 100. In this embodiment (not shown), the second electrochemical half-cell 200 is replaced by a wire.

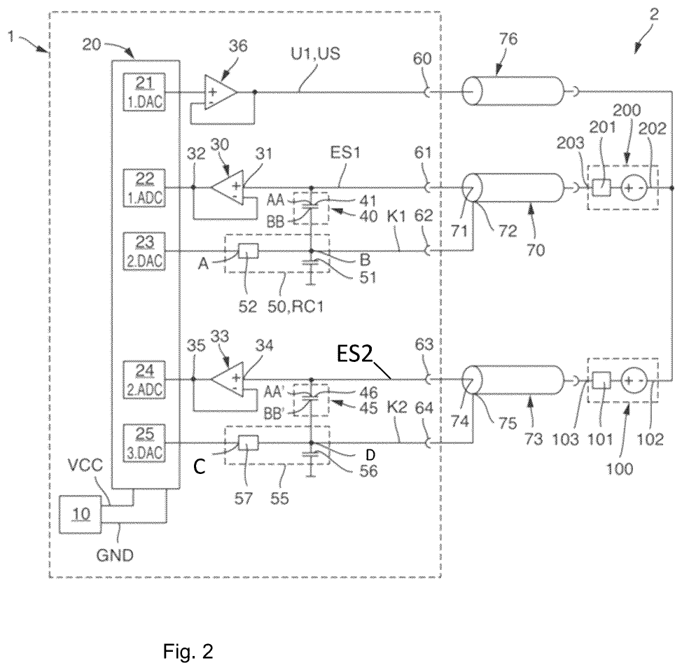

The first cable 70 is preferably a shielded cable. A shielded cable has at least one inner line and an outer shielding which protects the inner line in particular against electromagnetic radiation. The measurement medium with the analyte can optionally also be contacted directly via an additional potential equalization line (see third cable 76 in FIG. 2, which is connected to the terminals 202 and 102 of the equivalent circuit diagrams of the electrochemical half-cells). In general, it should be noted at this point that a shielded cable resembles a capacitor in its electrostatic behavior in certain regions. A shielded cable, i.e., for example, a coaxial cable, therefore has a capacitance between the inner conductor and the outer conductor. In a first approximation, such a shielded cable can therefore be considered as a capacitor with a capacitance C_coax. Accordingly, a change over time (d U_coax/dt) in the voltage U_coax, which is measured between the inner line and the outer shielding, can be used to infer the effective charge/discharge current I_coax of the “capacitor”, i.e. the shielded cable, as follows: I_coax=C_coax (d U_coax/dt). If this charge/discharge current I_coax flows via a sensor half-cell with high impedance R_sens, this charge/discharge current I_coax generates a voltage drop U_Rsens at the resistor R_sens, which voltage drop can be calculated as follows: U_Rsens=R_sens*I_coax=R_sens*C_coax*(d U_coax/dt).

The sensor circuit 1 has a voltage source 10, a control unit 20, a first impedance converter 30, a first input filter 40, a first output filter 50, a first terminal 60 and a second terminal 61.

The voltage source 10 is connected to the control unit 20 and is suitable for providing a first voltage potential VCC and a second voltage potential GND to the control unit 20. For example, the voltage source 10 provides the voltage potentials VCC, GND via two separate lines of the control unit 20. The voltage source 10 preferably provides a unipolar operating voltage. The first voltage potential VCC is, for example, 2.5 V greater than the second voltage potential GND. The first voltage potential VCC is, for example, between 1.8 V and 5 V.

The control unit 20 has a first digital-analog converter 21, a first analog-digital converter 22, and a second digital-analog converter 23. The second digital-analog converter 23 can be designed as a pulse-width modulator. One advantage of using pulse-width modulators is that they are usually installed in greater numbers in conventional microcontrollers and require less current as an analog-digital converter with continuous output levels. The control unit 20 is, for example, a microcontroller. The task of the second digital-analog converter 23 is to output a DC voltage signal and to supply it to a filter circuit (first output filter 50).

The first impedance converter 30 has an input 31 and an output 32. The input 31 of the first impedance converter 30 is connected to an input AA of the first input filter 40 and to the second terminal 61. The output 32 of the first impedance converter 30 is connected to the first analog-digital converter 22.

The first input filter 40 has an input AA and an output BB. The first input filter 40 comprises at least one first capacitor 41. The first capacitor 41 has a capacitance of at least 220 pF, preferably of at least 1 nF.

The first output filter 50 has an input A and an output B and connects the output of the second digital-analog converter 23 to the first input filter 40 and, if required, mutually decouples the first input filter 40 and the second digital-analog converter 23 alternately from internal and external interference signals that may be present. If interference signals are not to be expected at the digital-analog converter 23 nor at the input, a direct connection of input A and output B is also possible, i.e. without the output filter 50.

The output filter 50 advantageously has a first capacitor 51 and a first resistor 52. The first output filter 50 therefore forms a first RC element RC1. The RC element is preferably a low-pass. The first capacitor 51 of the first RC element RC1 preferably has a capacitance which is significantly greater than that of the first capacitor 41 of the first input filter 40. For example, the first capacitor 41 of the first input filter 40 has a capacitance of 1 nF, and the first capacitor 51 of the first output filter 50 has a capacitance, for example, of ten times higher, that is, for example, 10 nF. The second digital-analog converter 23 is connected to the input A of the first output filter 50. The output B of the first output filter 50 is connected to the output BB of the first input filter 40. The first capacitor 51 is connected to a first terminal between the resistor 52 and the output B and connected to a second terminal with a voltage potential, e.g., the ground potential.

The first terminal 60 is suitable for connecting the first cable 70 or another cable. For example, a shielding 72 of the first cable is connected to the first terminal 60. The second terminal 61 is also suitable for connecting the first cable 70 or another cable. For example, an inner conductor 71 of the first cable 70 is connected to the second terminal 61 (see FIG. 1).

The first terminal 60 is connected to the first digital-analog converter 21. The second terminal 61 is connected to the input 31 of the first impedance converter 30 and to the input AA of the first input filter 40.

The first electrochemical half-cell 100 has an intrinsic resistance 101, an input 102 and an output 103. The second electrochemical half-cell 200 has an intrinsic resistance 201, an input 202 and an output 203. The intrinsic resistances are also called series impedances. The first electrochemical half-cell 100 is suitable for forming a DC voltage potential and providing it at the output 103 of the first electrochemical half-cell 100. The second electrochemical half-cell 200 is suitable for forming a DC voltage potential and providing it at the output 203 of the second electrochemical half-cell 200.

As in the first embodiment of the electrochemical measuring point 2 shown in FIG. 1, the outlet 103 of the first electrochemical half-cell 100 is connected to the shielding 72 of the first cable 70, and the output 203 of the second electrochemical half-cell 200 is connected to the inner conductor 71 of the first cable 70. The input 202 of the second electrochemical half-cell 200 is connected via the measurement medium (not shown) to the input 102 of the first electrochemical half-cell 100.

In the embodiment of FIG. 1, there is no direct additional connection of the evaluation electronics via a so-called potential equalization line (exposed connection to the input 202 and 102 of the equivalent circuit diagram) with the measurement medium. However, as shown in FIG. 2, for example, this can alternatively take place via an additional cable connection (third cable 76), for example in order to be able to reliably prevent current flows via one of the two half-cells in applications such as electroplating baths in which the measurement medium is energized with the analyte.

As shown in FIG. 1, a third impedance converter 36 can be connected by its input to the first digital-analog converter 21 and by its output to the first terminal 60.

FIG. 2 shows an alternative second embodiment of the electrochemical measuring point 2 with an alternative embodiment of the sensor circuit 1 and three cables 70, 73, 76. In addition to the first cable 70, a second cable 73 having an inner conductor 74 and a shielding 75 and a third cable 76 are present. The third cable 76 can also have a shielding.

In the alternative second embodiment of the sensor circuit 1 shown in FIG. 2, the control unit 20 furthermore has a second analog-digital converter 24 and a third digital-analog converter 25. The sensor circuit 1 furthermore has a third terminal 62, a fourth terminal 63, a fifth terminal 64, a second input filter 45 with an input AA′ and an output BB′, a second output filter 55 with an input C and an output D, and a second impedance converter 33 with an input 34 and an output 35. The output 35 is connected to the second analog-digital converter 24, and the input 34 is connected to the fourth terminal 63. The input AA′ of the second input filter 45 is connected to the input 34 of the second impedance converter 33, and the input C of the second output filter 55 is connected to the third digital-analog converter 25, and the output D of the second output filter 55 is connected to the output BB′ of the second input filter 45 and to the fifth terminal 64. The second input filter 45 is constructed like the first input filter 40 and has a capacitor 46. The second output filter 55 is constructed like the first output filter 50 and has a resistor 57 and a capacitor 56.

In the second embodiment of the electrochemical measuring point 2 shown in FIG. 2, the third cable 76 is connected to the first terminal 60 and to the input 202 of the second half-cell 200. The inner conductor 71 of the first cable 70 is connected to the second terminal 61 and the output 203 of the second half-cell 200, and the third terminal 62 is connected to the shielding 72 of the first cable 70. The inner conductor 74 of the second cable 73 is connected to the fourth terminal 63 and to the output 103 of the first half-cell 100. The fifth terminal 64 is connected to the shielding 75 of the third cable 73. The above-described capacitances of the coaxial cable, i.e. of the first cable 70 and of the second cable 73, are connected in parallel to the filter capacitors of the first and second input filters 40 and 45, whereby the same voltage drop as across the first or second input filters 40, 45 results between the inner conductor 71 or 74 of the first or second cable 70, 73 and the coaxial shielding 72, 75 of the first or second cable 70, 73.

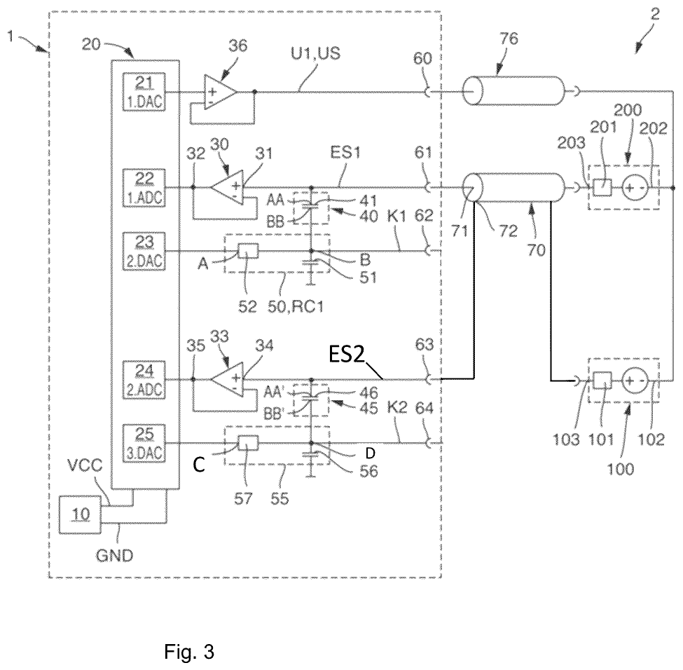

In the third embodiment of the electrochemical measuring point 2 shown in FIG. 3, the embodiment shown in FIG. 2 differs in that a second cable 73 is unnecessary. However, in the embodiment shown in FIG. 3, the coaxial shielding 72 of the first cable 70 is connected to the fourth terminal 63 and the output of the first electrochemical half-cell 103.

The sensor circuit 1 enables a signal, e.g. as voltage or current, to be output on one or more signal outputs of the control unit 20, i.e. on the first digital-analog converter 21, on the second digital-analog converter 23 and on the third digital-analog converter 25, in order to control the electrochemical half-cells 100, 200, and this signal can be connected to a circuit network consisting of capacitors and resistors with known impedance or known resistances. Via the first terminal 60, the second terminal 61, the third terminal 62, the fourth terminal 63 and the fifth terminal 64, it is possible to connect at least one electrochemical half-cell 100, 200 to the circuit network. At the signal inputs of the control unit 20, i.e. in the first analog-digital converter 22 and in the second analog-digital converter 24, it is possible to read in the first electrode signal ES1 or the second electrode signal ES2, i.e. a voltage or a current.

Furthermore, it is possible to modulate an AC voltage signal at at least one of the signal outputs of the control unit 20 to the output DC voltage signal. In addition, it is possible to deduce the resistance of the electrochemical half-cell 100, 200 via a frequency-dependent attenuation of the signal response, wherein the attenuation results from interconnecting the electrochemical half-cell 100, 200 and the circuit network, and wherein the signal response is formed by the AC voltage amplitudes measured by the control unit 20. A numerical approximation value for the resistance of the electrochemical half-cell 100, 200 is therefore available by means of the control unit 20.

For example, this is accomplished via a model-based approach. For this purpose, it is possible to calculate for given AC voltage signals which input signals would result in the control unit 20, i.e., which first electrode signal ES1 or which second electrode signal ES2 would result if the impedance of the electrochemical half-cell 100, 200 can assume a given value. In other words, under the hypothesis that the unknown circuit components of the electrochemical half-cells 100, 200 would have an assumed resistance R, for example, it is possible to calculate by means of the known capacitances and resistors of the circuit network which voltages would result at the signal inputs of the control unit 20 with the analog-to-digital converters 22, 24 under this assumption. A determined deviation between the values calculated under the assumptions for the cell impedance R of the electrochemical half-cells 100, 200 and the actually measured signal curves of the first electrode signal ES1 and the second electrode signal ES2 is a measure of the correctness of the hypothesis. An approach for estimating the impedance of the electrochemical half-cells 100, 200 is therefore to search for precisely the numerical value for the cell impedance R via an algorithm which, in the model, results in the smallest deviations between the actually measured electrode signals ES1, ES2 and the modeled signals. In this case, it is possible to determine one or more unknown parameters of the system, for example both the cable capacitance of a connection cable and an ohmic source impedance of the electrochemical half-cells 100, 200 since both may be unknown for the evaluation logic. Alternatively, it is also conceivable to let the possibly unknown cable length be set by the user, for example via an operating mask on a display, and therefore to estimate only the impedance of the sensor cell. Furthermore, it is also possible for the user to enter an estimated value for the sensor cell impedance.

The method according to the present disclosure for operating an electrochemical measuring point 2 is described below.

In a first step, the electrochemical measuring point 2 is provided according to the first, second or third embodiment described above. For the sake of simplicity, however, the method will first be described using the first embodiment of the sensor circuit 1 (see FIG. 1). Then the differences between the first embodiment and the second embodiment (see FIG. 2) or the third embodiment (see FIG. 3) of the electrochemical measuring point 2 will discussed. The provision of the electrochemical measuring point 2 comprises that it is naturally ready for operation. This means that the first electrochemical half-cell 100 and the second electrochemical half-cell 200 are in contact with a measurement medium. This is shown in FIG. 1 by the connection between the input 102 of the first electrochemical half-cell 100 and the input 202 of the second electrochemical half-cell 200.

Subsequently, a first electrode signal ES1 is measured at the second terminal 61. The first electrode signal ES1 is generated by the first electrochemical half-cell 100 or second electrochemical half-cell 200 and is provided at its output 103, or 203.

Then, the first electrode signal ES1 at the first analog-digital converter 22 is evaluated so that an AC voltage amplitude shift and/or a phase shift between the AC voltage signal WS1 and the first electrode signal ES1 is determined.

A first half-cell impedance of the first electrochemical half-cell 100 is then determined based on the AC voltage amplitude shift and/or the phase shift.

A filter capacitance of the first input filter 40 and a cable capacitance of the first cable 70 are then determined.

A time derivative ES1′ of the first electrode signal ES1 and a time derivative GS1′ of the DC voltage signal GS1 are then determined.

A first correction value is then determined based on the time derivative ES1′ of the first electrode signal and the time derivative GS1′ of the first DC voltage signal and the first half-cell impedance.

A measured value is then determined based on the first electrode signal ES1.

Then, a display value is determined based on the measured value and the first correction value.

Then, the display value is output.

Optional embodiments of the method are described below.

The first electrode signal ES1 is preferably a DC voltage signal with a modulated AC voltage component, wherein the AC voltage amplitude and phase of the signal depend on the sensor cell impedances 201, 101, i.e. the intrinsic resistances of the first and second electrochemical half-cells 100, 200.

Subsequently, a step of estimating the sensor cell impedances on the basis of the AC voltage components, for example as described above, is preferably carried out in the controller 20, i.e. based on the model by an adaptation algorithm, so that, as a result of this step of estimating in the controller 20, numerical values exist for the unknown components of the equivalent circuit diagram, for example estimated values for the resistances of the electrochemical half-cells 201, 101 and/or the cable capacitance of the connection lines 76, 70, 73. As described above, parts of the unknown parameters can also be made available by user inputs, for example by the operator of the device entering the length L of the connection cables via an input mask and the cable capacitance being determined by multiplying the length L with a typical capacitance coating (e.g., 100 pF capacitance per m cable length) of the cable.

The DC voltage value of the first electrode signal ES1 is, for example, dependent on an analyte concentration present in the measurement medium or the pH value of the solution. The first electrode signal ES1 is in principle the digitally determined differential voltage between the signal at the input of the first analog-digital converter 22 and the output of the first digital-analog converter 21, i.e. the potential difference between the cable connections 60 and 61. The first electrode signal ES1 is therefore the electrochemical voltage of the electrochemical measuring point 2. If the electrochemical measuring point 2 is a pH sensor, the pH of the measurement medium can be calculated based on the first electrode signal ES1.

In the step of measuring the first electrode signal ES1, there is preferably simultaneously an analog filtering of the first electrode signal ES1 by the first input filter 40 and optionally the first output filter 50. For example, the first electrode signal ES1 is smoothed by the first capacitor 41 of the first input filter 40. The filtering by the first output filter 50 comprises generating a filter signal by the second digital-analog converter 23 and feeding it into the first output filter 50. The filter signal influences the first electrode signal ES1 via the first input filter 40 connected to the first output filter 50. For filtering, the filter capacitors preferably have a very large capacitance, i.e. greater than 100 nF. The output filter 50 is particularly advantageous if a low-current pulse-width modulated digital signal is used as the filter signal for the digital-analog conversion in the second digital-analog converter 23.

Preferably, the voltage of the first electrode signal ES1 is measured and averaged over a time period dt1. This means that, for example, a mean value filter having a predetermined duration dt1 is used. The duration of the averaging is, for example, 1-3 seconds.

In a next step, a time derivative ES1′ of the first electrode signal ES1 is preferably determined by the control unit 20. The time derivative ES1′ of the first electrode signal ES1 is preferably stored in the control unit 20 for later evaluations in a memory.

This can be done, for example, in that, in a first step, the voltage of the signal ES1 averaged over the past duration dt1 of, for example, 3 seconds is detected with a shorter time frame DeltaT of, for example, 100 ms compared to dt1, so that a new mean value is calculated at a time interval DeltaT. A time series of values for ES1 therefore results in the control unit. The time derivative is then calculated from the difference between two successive values ES1_t0 and ES1_t1 via the relationship (ES1_t1−ES1_t0)/DeltaT.

Alternatively, the same time duration dt1, which is also used for averaging the DC voltage values, or a longer duration, can be used to determine the time derivative ES1′.

As an alternative to the above-described method which is based on a time series for averaged electrode signals, the time derivative can also be detected in such a way that the signal curves of the electrode signal ES1 are continuously detected and numerically integrated.

This can be done, for example, by first averaging the voltage values of the output and measured voltages over a time period dt1, e.g. integrating them by averaging (e.g. from dt1=DeltaT*32) and determining the time derivative UPoint(t) of a voltage t such that UPoint(t)=(“Integral over U over the time interval [t−DeltaT−dt1, t−DeltaT]”−“Integral over U over the time interval [t−dt1, t]”)/(DeltaT*dt1).

Advantageously, the time dt1 is selected such that it is a precise integer multiple of all time periods of the AC voltage frequencies that are output for those at the digital-analog converters for the purpose of impedance estimation at the sensor electrodes. If, for example, the lowest frequency for the impedance determination is ⅓ Hz, a time of 3 s or an integer multiple of 3 s is advantageous as the averaging time dt1. The calculation of the time derivative is therefore not falsified by the AC voltage signals modulated onto the output signals. For the duration DeltaT, a period is expediently selected with which the measuring device displays a new measured value on the display, or a new measured value is transmitted to an external control unit, i.e., for example, a time of 100 ms.

As a result of the preceding steps, the time derivatives are known on the one hand for all output signals at the signal outputs 21, 23, 25, and on the other hand measured values for the time derivatives of the input signals ES1, ES2 are also available.

According to one embodiment, a displacement current is determined for all capacitance values (and possibly inductance values) of the filter circuits 40, 50 and cables 70, which is determined from the time derivative of the voltage decreasing across the effective impedance and the known or estimated inductances or capacitances. For example, a coaxial cable 70 with a capacitance CCable, which is connected by its outer conductor 72 to a voltage VGuard with a time derivative VGuardPoint(t) output by a voltage source and by its inner conductor 71 to a measured voltage VInput(t) with a time derivative VInputPoint(t), has a charge/discharge current of ICharge/discharge(t)=CCable*(VInputPoint(t)−VGuardPoint(t)).

According to one embodiment of the present disclosure, the charge/discharge current generated by the tracking of the voltage sources of the circuit is deduced from the known component values for filter capacitors and their voltages.

By virtue of the determination of the charge/discharge currents, it is achieved that the voltage error generated by the charge/discharge currents in the cable can be calculated and therefore compensated. The voltage error can therefore be determined as a “voltage error”=“impedance of the sensor”*“sum of the charge/discharge currents.”

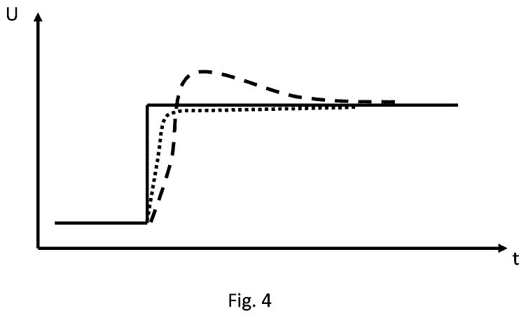

This “voltage error” is visible in particular in FIG. 4 from the dashed curve in the form of an overshoot compared to an ideal voltage curve (full curve). If the determined voltage error is now used as a correction value for correcting the measured value, i.e. the voltage measured at the half-cell or the first electrode signal ES1, the overshoot can be avoided, and even the response time of the displayed measurement signal (display signal) can be improved (see dotted curve in FIG. 4).

This is preferably followed by a step of outputting a superposition of a first DC voltage signal GS1 with a first AC voltage signal WS1 at the first terminal 60 by the first digital-analog converter 21. The DC voltage signal is advantageously tracked during operation to achieve optimum modulation of the analog-digital converters during operation, so it is actually a time-varying variable which, in contrast to the AC voltage signal, only varies at a very low frequency. In this sense, in comparison with the AC voltage, it is possible to effectively speak of a DC voltage source which, in contrast to the AC voltage signal, has only very small amounts of the time derivative GS1′. For example, to readjust the DC voltage GS1, it is tracked with a slowly varying ramp so that a new DC voltage setpoint is reached over a time period of 30 seconds, for example.

The AC voltage signal WS1 advantageously contains more than one oscillation frequency, for example two or three different frequencies.

The AC voltage signal WS1 has, for example, a frequency component with less than 50 Hz and/or a frequency component with more than 500 Hz.

For example, a superposition of two sine signals with different frequencies can be carried out. The voltage V_DAC at the output of the first digital-analog converter 21 therefore results, for example, from the formula:

$$U 1 = V\_DAC \_DC + V\_DAC \_F 1 * sin ( 2 * pi * F 1 ) + V\_DAC \_F 2 * sin ( 2 * pi * F 2 ) ,$$

with U1 as the first output voltage U1 of the first digital-analog converter 21, with V_DAC_DC as the DC voltage component of the first output voltage U1, with V_DAC_F1 as the AC voltage component of the first output voltage U1 of a first frequency F1, and with V_DAC_F2 as the AC voltage portion of the first output voltage U1 of a second frequency F2.

This is preferably followed by a step of evaluating the first electrode signal ES1 at the first analog-digital converter 22 so that the AC voltage amplitude shift and/or a phase shift between the DC voltage signal GS1 and/or the AC voltage signal WS1 (i.e. the output signal of the first digital-analog converter 21) and the first electrode signal ES1 (i.e. the input signal at the first analog-digital converter 22) is determined, from which the cable capacitances of the first cable 70 (and if present of the second cable 73) and the source impedances or intrinsic resistances 101, 201 of the first electrochemical half-cell 100 or of the second electrochemical half-cell 200 can be inferred.

The half-cell impedance of the first electrochemical half-cell 100 and the second electrochemical half-cell 200 is preferably determined based on the AC voltage amplitude shift and/or the phase shift.

This is preferably followed by a step of determining a sensor impedance on the basis of the cable impedance and the half-cell impedance.

In a further step, a correction value is preferably determined based on the time derivative ES1′, the known capacitances in the circuit, and the sensor impedance.

Subsequently, a measured value is preferably determined based on the first electrode signal ES1.

Furthermore, there is preferably a step of determining a display value based on the measured value and the correction value. This means that the measured DC voltage values, i.e. the first electrode signal ES1 of the first and second electrochemical half-cells 100, 200, are corrected before the output, for example on a display or on a fieldbus interface to a control center, in order to correct the estimated voltage error value, i.e. the correction value.

Advantageously, after subtracting the estimated voltage error signals, i.e. after the correction of the measured value by the correction value, there is a moving mean value filtering with adaptively controlled averaging times. This means that a short averaging time is used for rapidly variable voltages, and a long averaging time is used for virtually constant voltages.

Finally, the display value, i.e. the corrected measured value, is preferably output. The display value is output by the control unit 20, for example, to an external device to be displayed, which is connected wirelessly or by cable to the electrochemical sensor 2, or is output directly on a display integrated, for example, in the sensor circuit 1 to be displayed.

This ensures that the output display value reflects the actual measured value faster than would be possible without a correction value (see dotted curve in FIG. 4).

Specifically, the correction values can be determined using the example of the sensor wiring from FIG. 3, for example, as indicated below. The capacitances relevant therein in the connection line 61 are formed on the one hand by the capacitance of the cable 70 between the inner conductor 71 and the outer conductor 72. On the other hand, the capacitance value of the filter circuit 40 is decisive. For determining the correction value, the filter circuit 40 can be considered as a capacitor 41 which connects the first electrode signal ES1 to the signal B driven by the digital-analog converter 23. On the other hand, the cable 70 acts as a capacitor with a cable capacitance C_Coax_70 between the second electrode signal ES2 and the first electrode signal ES1.

If the first electrode signal ES1, the second electrode signal ES2, and the signal at the output B of the first output filter 50 have static curves that do not change over time, no displacement current flows via the capacitors. However, if the signal ES1, ES2 or B changes over time, i.e. the time derivative ES1′, ES2′ or B′ thereof is not equal to zero, displacement currents become effective. The charging current via the capacitor 41 is then calculated as I_C41=C*(ES1′−B′) from the time derivative of the signal ES1 and the signal B. The time derivative of the signal B can thereby be determined via the time characteristic of the output control signal of the second digital-analog converter 23. The signal curves of the signals ES1 and ES2 are obtained from the measurements at the first and second analog-digital converter 22 and 24. Accordingly, the displacement current is obtained via the cable capacitance as I_Coax_70=C_Coax_70*(ES1′−ES2′). The total capacitor current I_C41+I_Coax_70 is therefore effective at the signal node ES1. Since the amplifier 31 operated as an impedance converter has a very high impedance at the input, this total charge/discharge current must flow via the effective resistor R_201 of the connected half-cell, and there generates the voltage drop R_201*(I_C41+I_Coax_70) to be taken into account as a correction signal.

Given knowledge of the DC voltage value of the first electrode signal ES1 and the voltage drop across the resistor 201 to be taken into account as a correction signal, a display value can therefore be determined which corresponds to the voltage value of the voltage source 202 of the half-cell connected to the terminal 61.

Accordingly, a correction value for the voltage drop across the resistor 101 is calculated as a correction signal for the voltage source 102 of the half-cell 100, which is from the charge/discharge currents across the capacitor 46 of the filter 45 effective for the signal ES2 and the negative charge/discharge current I_Coax_70, as well as the value of the resistor 101.

The same applies to FIG. 2, wherein the time derivative of the voltage curves of the signals B and ES1 is decisive for the charge/discharge current of the capacitance of the coaxial cable 70, and the time derivative of the signals D and ES2 is decisive for the charge/discharge current of the capacitance of the cable 73.

FIG. 4 shows, by way of example, the result after subtracting the correction signals, such as arises in a circuit according to FIG. 2 in the method according to the present disclosure. The solid line therein outlines the actual curve of the voltage of the signal source 201 over time. The dashed line outlines the associated curve of the signal ES1 measured at the ADC. Over the course of time, the guard signal B is tracked in such a way that this guard signal is tracked with a slow ramp to the value of the electrode signal ES1 in order to avoid leakage currents via the cable 70 and the filter 40 between the signal B and ES1. This tracking is expressed in a charge/discharge current via the capacitor 41 and the capacitance of the cable 70 and causes an overshoot in the form of the dashed line. The dotted line in FIG. 3 shows the result for the output value, where the calculated voltage drop at the half-cell impedance of ES1 was subtracted in order to compensate for the effect of the recharging currents. Advantageously, as explained above, to determine the time derivative of the signals that are used for the correction calculation, an integration is first performed over the time period of the AC voltage signals output to the DAC, which are used to determine the half-cell impedances 201 and 101.

1. A method for operating an electrochemical measuring point, the method comprising:
providing the electrochemical measuring point with a sensor circuit, a first cable, and a first electrochemical half-cell, wherein the sensor circuit has a control unit with a first digital-analog converter, a first analog-digital converter, and a second digital-analog converter, wherein the sensor circuit furthermore has a first terminal, a second terminal, and a first input filter arranged between the second digital-analog converter and the second terminal;
measuring a first electrode signal of the first electrochemical half-cell at the second terminal;
outputting a superposition of a first DC voltage signal with a first AC voltage signal at the first terminal by the first digital-analog converter;
evaluating the first electrode signal at the first analog-digital converter so that an AC voltage amplitude shift and/or a phase shift between the AC voltage signal and the first electrode signal is determined;
determining a first half-cell impedance of the first electrochemical half-cell based on the AC voltage amplitude shift and/or the phase shift;
determining a filter capacitance of the first input filter and/or a cable capacitance of the first cable;
determining a time derivative of the first electrode signal and a time derivative of the DC voltage signal;
determining a first correction value based on the time derivative of the first electrode signal and the time derivative of the first DC voltage signal and the first half-cell impedance;
determining a measured value based on the first electrode signal;
determining a display value based on the measured value and the first correction value; and
outputting the display value.

2. The method according to claim 1, wherein a guard voltage is output by the digital-analog converter to the second terminal, and a displacement current is determined based on a voltage difference between the first terminal and the second terminal and the cable impedance, wherein the displacement current is taken into account in the step of determining the first correction value.

3. The method according to claim 1, wherein a time period of less than 3 seconds is used when determining the time derivative of the first electrode signal.

4. The method according to claim 1, wherein a cable length of the first cable is entered by the user and is taken into account when determining the cable capacitance.

5. The method according to claim 1, wherein when determining the half-cell impedance, a median filtering or mean value filtering is applied to values of the determined AC voltage amplitude shift and/or values of the determined phase shift to the determined values of the half-cell impedance.

6. A method for operating an electrochemical measuring point, the method comprising:
providing the electrochemical measuring point with a sensor circuit, a first cable, a second cable, a third cable, a first electrochemical half-cell, and a second electrochemical half-cell, wherein the sensor circuit has a control unit with a first digital-analog converter, a first analog-digital converter, and a second digital-analog converter, wherein the sensor circuit furthermore has a first terminal, a second terminal, and a first input filter arranged between the second digital-analog converter and the second terminal;
measuring a first electrode signal of the first electrochemical half-cell at the second terminal;
determining a time derivative of the first electrode signal and a time derivative of the second electrode signal at the fourth terminal;
outputting a superposition of a first DC voltage signal with a first AC voltage signal at the first terminal by the first digital-analog converter;
evaluating the first electrode signal at the first analog-digital converter and evaluating the second electrode signal at the second analog-digital converter so that in each case an AC voltage amplitude shift and/or a phase shift between the DC voltage signal or the AC voltage signal and the first and second electrode signal is determined;
determining a first half-cell impedance of the first electrochemical half-cell and a second half-cell impedance of the second electrochemical half-cell based on the AC voltage amplitude shift and/or the phase shift;
determining a first correction value based on the time derivative of the first electrode signal and the first half-cell impedance of the first half-cell;
determining a second correction value based on the time derivative of the second electrode signal and the second half-cell impedance of the second half-cell;
determining a measured value based on the first electrode signal and the second electrode signal;
determining a display value based on the measured value and the first correction value and the second correction value; and
outputting the display value.

7. An electrochemical measuring point, comprising:
a sensor circuit having a control unit, wherein the sensor circuit further comprises a first terminal and a second terminal;
a first cable having an inner conductor and a shielding, wherein the shielding is connected to the first terminal and the inner conductor is connected to the second terminal;
a first electrochemical half-cell having an input and an output; and
a second electrochemical half-cell having an input and an output,
wherein the input of the first electrochemical half-cell is suitable for being connected to a measurement medium, and the output of the first electrochemical half-cell is connected to the shielding,
wherein the input of the second electrochemical half-cell is suitable for being connected to the measurement medium, and the output of the second electrochemical half-cell is connected to the inner conductor.

8. An electrochemical measuring point, comprising:
a sensor circuit having a control unit, wherein the sensor circuit further comprises a first terminal, a second terminal, a third terminal, a fourth terminal and a fifth terminal;
a first electrochemical half-cell having an input and an output;
a second electrochemical half-cell having an input and an output;
a first cable having an inner conductor and a shielding, wherein the inner conductor of the first cable is connected to the second terminal and to the output of the second half-cell, and the third terminal is connected to the shielding of the first cable;
a second cable having an inner conductor and a shielding, wherein the inner conductor of the second cable is connected to the fourth terminal and to the output of the first half-cell, and the shielding of the second cable is connected to the fifth terminal; and
a third cable, wherein the third cable is connected to the first terminal and is connected to the input of the first half-cell and to the input of the second half-cell.

9. An electrochemical measuring point, comprising:
a sensor circuit having a control unit, wherein the sensor circuit comprises a first terminal, a second terminal, a third terminal, and a fourth terminal;
a first electrochemical half-cell having an input and an output;
a second electrochemical half-cell having an input and an output;
a first cable having an inner conductor and a shielding, wherein the inner conductor of the first cable is connected to the second terminal and to the output of the second half-cell, the fourth terminal is connected to the shielding of the first cable, and the shielding is further connected to the output of the first half-cell; and
a third cable, wherein the third cable is connected to the first terminal and is connected to the input of the first half-cell and to the input of the second half-cell.
